(19) United States
(12) Patent Application Publication
(10) Pub. No.: US 2015/0059555 A1
(43) Pub. Date: Mar. 5, 2015

(54) PORTABLE CAJON HITTING ASSEMBLY

(71) Applicant: Tsun-Chi LIAO, Taichung (TW)

(72) Inventor: Tsun-Chi LIAO, Taichung (TW)

(21) Appl. No.: 14/245,384

(22) Filed: Apr. 4, 2014

(30) Foreign Application Priority Data
Sep. 3, 2013 (TW) 102216520

(51) Int. Cl. G10D 13/00

(52) U.S. Cl. CPC G10D 13/003
USPC 84/422.1

(57) ABSTRACT

A portable cajon hitting assembly comprises a foot pedal, a wire tube, an upright plank, a bracing bar, a hitter and a holding rack. The wire tube is threaded by a drawing wire having a start end and a distal end. The upright plank has a turnable axle. The foot pedal is connected to the start end of the drawing wire through a chain. The bracing bar has two ends fastened respectively to the axle and the distal end of the drawing wire. The hitter is fastened to the axle. The holding rack clamps and holds a cajon. Thus, through relative positions of the bracing bar and drawing wire and a lever action, the drawing wire can draw the axle to turn at an optimal angle, and also increase instantaneous torsional force to enhance smoothness during treading of the foot pedal. Moreover, the invention also can be stored easily.

### FIELD OF THE INVENTION

The present invention relates to a drum hitting assembly and particularly to a cajon hitting assembly.

### BACKGROUND OF THE INVENTION

A cajon looks like a stool which can be sat by people and hit at various locations to generate different sounds, and thus is desirable for impromptu performance. The cajon is constructed like an empty wooden chest with a round hole perforated on the back side as a sound outlet. At the front of the wooden chest, there is a snare installed therein to generate timbre like a snare drum.

Please refer to FIG. 1, in order to facilitate hitting convenience and enhance versatility, a cajon can be used to serve as an ancillary hitting device. A conventional cajon comprises a foot pedal 1, a first upright stand 2, a wire tube 3, a second upright stand 4, a hitter 5 and a holding rack 6. The holding rack 6 holds a cajon 7. The second upright stand 4 has a turnable axle 8. The hitter 5 is fastened to the axle 8 and faces the cajon 7. The wire tube 3 is threaded by a drawing wire (not shown in the drawing) inside that has one end connected to the hitter 5 and another end connected to the foot pedal 1. The foot pedal 1 is located on the first upright stand 2. Stepping on the foot pedal 1, the drawing wire can be drawn to drive the axle 8 to turn, and thereby drive the hitter 5 to hit the cajon 7.

The cajon hitting assembly can increase the versatility of hitting the cajon 7 to further enhance appeal of performances. Through the drawing wire threading through the wire tube 3, the position of the foot pedal 1 can be adjusted as desired to suit user's use requirements. The movement generated by the downward stepping on the foot pedal 1 directly draws the drawing wire to move that in turn drives the hitter 5 to turn. However, the moving displacement of the drawing wire is relatively small, and the torsional force being generated also is inadequate, and the foot pedal often feels like being jammed when stepped. All these leave a lot to be desired during hitting of the cajon 7.

To remedy the aforesaid problems of insufficient wire drawing displacement and deficiency in the generated torsional force, another type of conventional cajon has been developed as shown in FIG. 2. It comprises a first upright stand 9, a first bracing bar 10, a second upright stand 11, a second bracing bar 12, a foot pedal 13, a wire tube 14, a hitter 15 and a holding rack 16. The first upright stand 9 has a turnable first axle 17 located thereon. The first bracing bar 10 has one end fastened to the first axle 17. The second upright stand 11 has a turnable second axle 18 located thereon. The second bracing bar 12 has one end fastened to the second axle 18. The foot pedal 13 can drive the first axle 17 to turn.

The wire tube 14 is threaded by a drawing wire 19 which has a start end and a distal end, and has two ends fastened respectively to the first upright stand 9 and second upright stand 11. The start end of the drawing wire 19 is fastened to the first bracing bar 10 and spaced from the first axle 17 at a first distance. The distal end of the drawing wire 19 is fastened to the second bracing bar 12 and spaced from the second axle 18 at a second distance. The hitter 15 is fastened to the second axle 18.

By means of the structure set forth above, the relative positions of the first bracing bar 10, the second bracing bar 12 and the drawing wire 19, and a lever action being formed, the drawing wire 19 can draw the first axle 17 and second axle 18 to turn at an optimal angle, and thereby increase the instantaneous torsional force to enhance smoothness when the foot pedal is stepped.

However, the aforesaid conventional structure involves a great number of components and thus is difficult to assemble. Moreover, the first upright stand 9 and second upright stand 11 are bulky in size, and hence are difficult to store and carry around.

### SUMMARY OF THE INVENTION

The primary object of the present invention is to provide a portable cajon hitting assembly to offer smoother foot treading during hitting of a cajon and make carrying around easier.

To achieve the foregoing object, the portable cajon hitting assembly according to the invention aims to hit a cajon and to be carried around easily. It comprises an upright stand, a wire tube, a foot pedal, an upright plank, a bracing bar, a hitter and a holding rack. The wire tube is threaded by a drawing wire which has a start end and a distal end. The foot pedal is fixedly mounted on the upright stand and connected to the start end of the drawing wire through a chain to move the drawing wire. The upright plank has a turnable axle. The bracing bar has two ends fastened respectively to the axle and the distal end of the drawing wire. The hitter is fastened to the axle. The holding rack is fastened to the upright plank to clamp and hold the cajon.

Thus, when the foot pedal is treaded to move the hitter to hit the cajon, the relative positions of the bracing bar and drawing wire are at a right angle. As a result, the drawing wire can draw the axle to turn at an optimal angle. Moreover, through a lever action, the instantaneous torsional force can be increased to enhance stepping smoothness. The invention is simpler in structure and can be packed in an elongate shape to facilitate storing, and also can be easily held in a handbag to be carried around conveniently, thus can better meet use requirements.

The foregoing, as well as additional objects, features and advantages of the invention will be more readily apparent from the following embodiment and detailed description, which proceeds with reference to the accompanying drawings. The embodiment serves merely for illustrative purpose and is not the limitation of the invention.

### BRIEF DESCRIPTION OF THE DRAWINGS

FIG. 1 is a perspective view of the structure of a conventional technique.

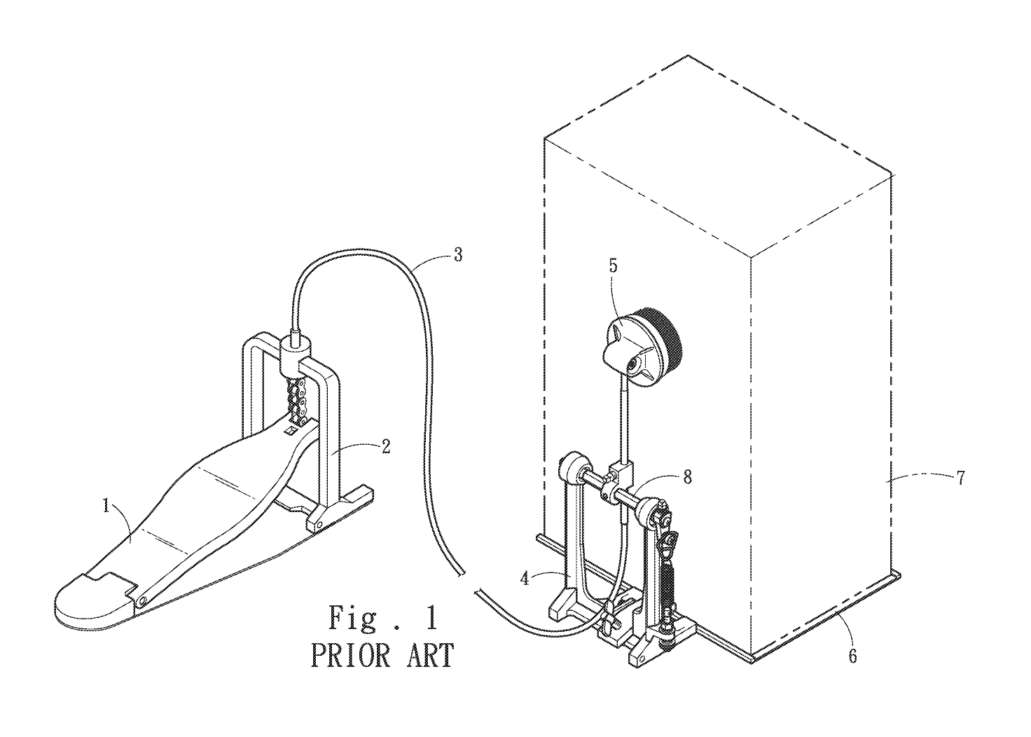

FIG. 2 is a perspective view of the structure of another conventional technique.

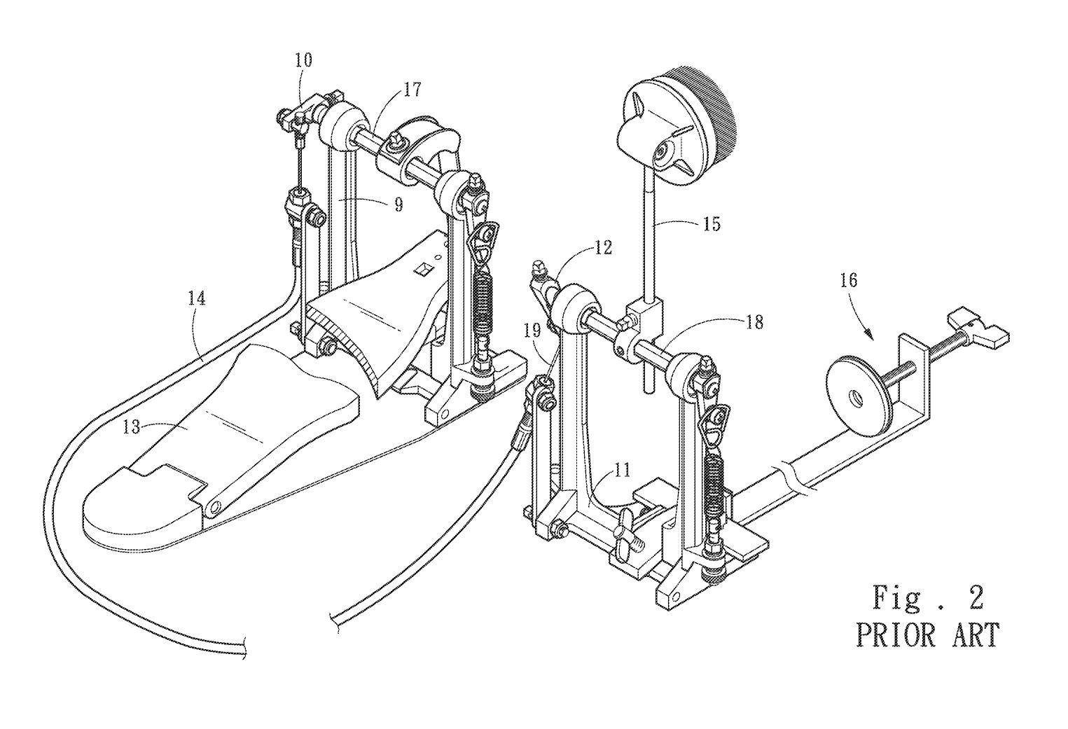

FIG. 3 is a perspective view of the invention.

FIG. 4 is a schematic view of the invention in a use condition.

FIG. 5 is a schematic view of the invention in a stored condition.

### DETAILED DESCRIPTION OF THE PREFERRED EMBODIMENT

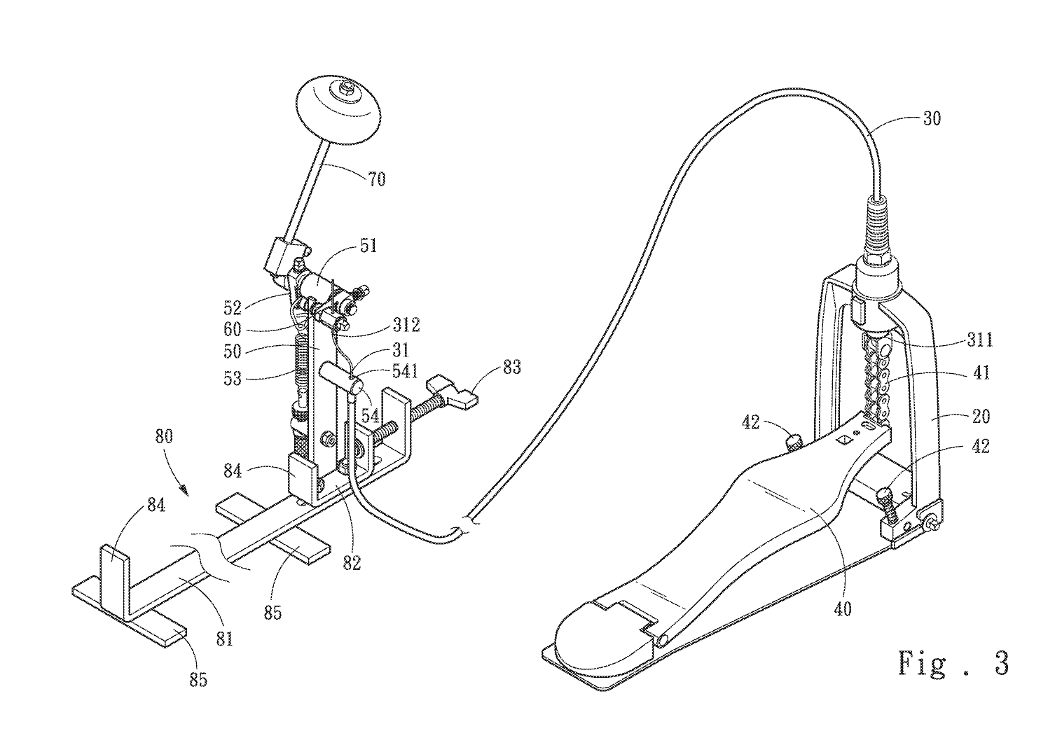

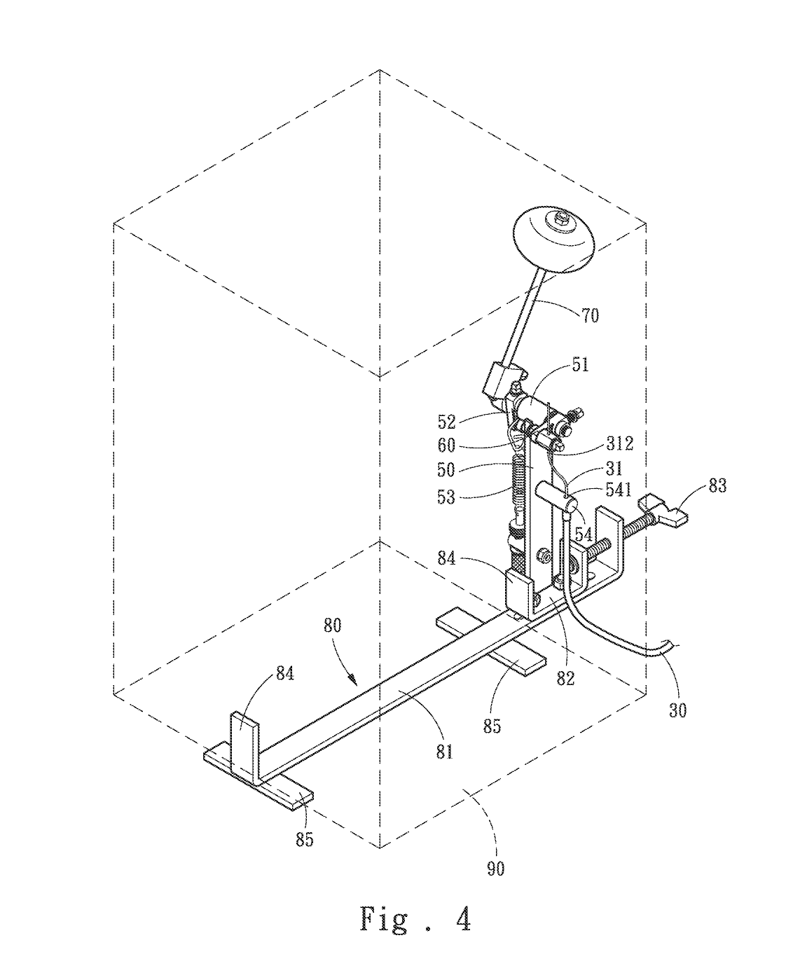

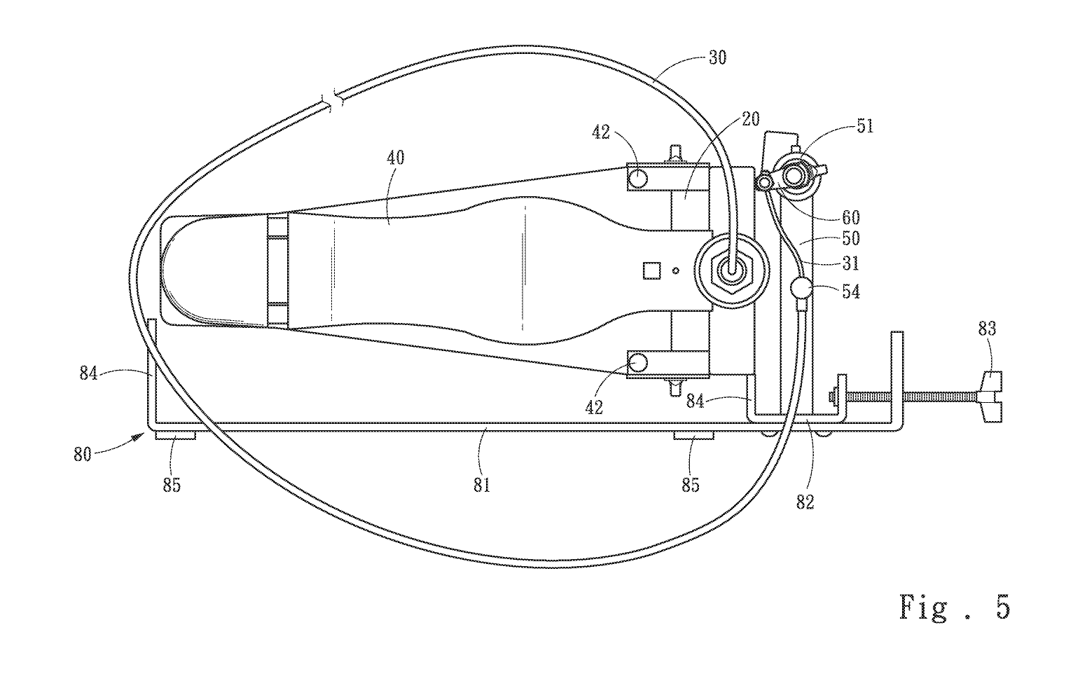

Please refer to FIGS. 3, 4 and 5, the present invention aims to provide a portable cajon hitting assembly to hit a cajon 90. It comprises an upright stand 20, a wire tube 30, a foot pedal 40, an upright plank 50, a bracing bar 60, a hitter 70 and a holding rack 80. The wire tube 30 is threaded by a drawing wire 31 which has a start end 311 and a distal end 312. The foot pedal 40 is fixedly mounted on the upright stand 20 and connected to the start end 311 of the drawing wire 31 through a chain 41 to move the drawing wire 31. The foot pedal 40 is run through by two elevation adjustment screws 42 to aid the foot pedal 40 to be steadily rested on a floor.

The upright plank 50 has a turnable axle 51. The axle 51 is extended downwards to form a gripping bar 52. The upright plank 50 and gripping bar 52 are bridged by an elastic element 53. The bracing bar 60 has two ends fastened respectively to the axle 51 and the distal end 312 of the drawing wire 31. The hitter 70 is fastened to the axle 51. The holding rack 80 is fastened to the upright plank 50 to clamp and hold the cajon 90.

The upright plank 50 also can have a support bar 54. The wire tube 30 has two ends fastened respectively to the support bar 54 and upright stand 20. The support bar 54 can have an oriented hole 541 to hold the wire tube 30. The oriented hole 541 faces the bracing bar 60 to allow the drawing wire 31 to draw the bracing bar 60 at a vertical angle.

In addition, the holding rack 80 can have a support plate 81 rested on the floor and a movable plate 82 fastened to the upright plank 50. The movable plate 82 can slide against the support plate 81. The support plate 81 also can be fastened to at least one transverse support board 85 and can be screwed by an adjustment element 83 which has a distal end turnable and latched on the movable plate 82. The movable plate 82 and support plate 81 have respectively a protrusive portion 84 opposing each other to clamp the cajon 90. Hence by turning the adjustment element 83, the position of the movable plate 82 can be changed to suit the cajon 90 with different sizes.

Thus, with the bracing bar and drawing wire positioned at a right angle relative to each other, when the foot pedal is treaded to move the hitter to hit the cajon, the drawing wire can be drawn to turn the axle at an optimal angle, and also increase the instantaneous torsional force through a lever action to enhance smoothness of the foot pedal during treading. The invention is simpler in structure and packed in an elongate shape, hence can facilitate storing and also can be held in a handbag conveniently to make carrying around easier, thereby can better meet use requirements.

What is claimed is:

1. A portable cajon hitting assembly to hit a cajon, comprising:
an upright stand;
a wire tube threaded through by a drawing wire which includes a start end and a distal end;
a foot pedal which is mounted on the upright stand and connected to the start end through a chain to move the drawing wire;
an upright plank to hold an axle which is turnable;
a bracing bar including two ends fastened respectively to the axle and the distal end of the drawing wire;
a hitter fastened to the axle; and
a holding rack fastened to the upright plank to clamp and hold the cajon.

2. The portable cajon hitting assembly of claim 1, wherein the axle is extended downward to form a gripping bar, the upright plank and the gripping bar being bridged by an elastic element.

3. The portable cajon hitting assembly of claim 1, wherein the wire tube includes one end fastened to the upright stand.

4. The portable cajon hitting assembly of claim 1, wherein the upright plank includes a support bar, the wire tube including another end fastened to the support bar.

5. The portable cajon hitting assembly of claim 4, wherein the support bar includes an oriented hole facing the bracing bar to hold the wire tube.

6. The portable cajon hitting assembly of claim 1, wherein the holding rack includes a support plate rested on a floor and a movable plate fastened to the upright plank and slidable against the support plate.

7. The portable cajon hitting assembly of claim 6, wherein the support plate is fastened to at least one transverse support board.

8. The portable cajon hitting assembly of claim 6, wherein the support plate is screwed by an adjustment element which includes a distal end turnable and latched on the movable plate.

9. The portable cajon hitting assembly of claim 8, wherein the movable plate and the support plate include respectively a protrusive portion opposing each other to clamp and hold the cajon.

10. The portable cajon hitting assembly of claim 1, wherein the foot pedal is run through by two elevation adjustment screws.
